(19) United States
(12) Patent Application Publication
(10) Pub. No.: US 2026/0169510 A1
(43) Pub. Date: Jun. 18, 2026

(54) PASS DEVICE

(71) Applicant: Renesas Design (UK) Limited, Bourne End (GB)

(72) Inventors: Daniel PIZZATO, Zurich (CH); Fabio DI FAZIO, Zurich (CH); Chiara MARTELLI, Zurich (CH); Prantik MAHAJAN, Dresden (DE)

(73) Assignee: Renesas Design (UK) Limited, Bourne End (GB)

(21) Appl. No.: 18/985,604

(22) Filed: Dec. 18, 2024

(51) Int. Cl. G05F 1/575; G05F 1/571

(52) U.S. Cl. CPC G05F 1/575; G05F 1/571

(57) ABSTRACT

An apparatus including a pass device is provided. The pass device includes a plurality of transistor slices coupled in parallel. Each of the plurality of transistor slices includes a switch transistor configured to be switchable between an on state and an off state, and a current source transistor coupled in series with the switch transistor and configured to set a first current to flow in the transistor slice when the switch transistor is in the on state.

The present disclosure relates to a pass device.

### BACKGROUND

FIG. 1 is a schematic of a known digital low dropout regulator (LDO) 100 for receiving an input voltage Vi and generating an output voltage Vo and providing the output voltage Vo to a load 101. The Digital LDO 100 comprises an error amplifier 102 between a reference voltage Vref and the output voltage Vo, a control logic circuit 104 and a pass device 106.

The pass device 106 comprises an array of small power transistors 108 that operate as switches.

Each transistor 108 in the FIG. 1 is part of a “slice”, and the combination of all slices is considered as the “total pass device”. The use of power transistors as switches facilitates low VDD power management and process scalability which makes Digital LDOs a good potential candidate for power management as we go to lower nodes.

In Digital LDOs one of the main disadvantages is having poor control over the current delivered by each single portion (slice) of the total pass device when it is activated; this is due to the fact that the operating region of the activated transistors can be different due to the dropout voltage of the LDO, thus different Vds (drain to source voltage, in case of NMOS) or Vsd (source to drain voltage, in case of PMOS).

This means that for the same number of activated slices, the total delivered current can be different depending on the dropout voltage. In other words, the total deliverable maximum current strongly depends on the process, voltage and temperature variation, since with the same number of activated slices the delivered current can be very different. As such, to have precise information about the total delivered current, a separate current sensing circuit is then needed, which increases the complexity, size and power requirements of the circuit.

Other solutions present a reference branch where a known current is pushed on a reference transistor, so that when other slices are activated, the conditions seen by the reference transistor (i.e. drain and source voltages) are copied on the activated slices. The disadvantage of this architecture is the fact that even the reference transistor can experience a change in its operating conditions, i.e. crossing back and forth triode and saturation region depending on the dropout voltage, and the quality of the current copy becomes poor.

### SUMMARY

It is desirable to provide an improved pass device that mitigates or overcomes one or more of the aforementioned problems.

According to a first aspect of the disclosure there is provided an apparatus comprising a pass device comprising a plurality of transistor slices coupled in parallel, wherein each of the plurality of transistor slices comprises a switch transistor configured to be switchable between an on state and an off state, and a current source transistor coupled in series with the switch transistor and configured to set a first current to flow in the transistor slice when the switch transistor is in the on state.

Optionally, the first current for each of the plurality of transistor slices is approximately equal to the first current of the other transistor slices.

Optionally, the apparatus comprises a reference circuit configured to control the current source transistors to set the first current for each of the plurality of transistor slices.

Optionally, the switch transistor of each of the plurality of transistor slices comprises a switch metal oxide semiconductor field effect transistor (MOSFET), and/or the current source transistor of each of the plurality of transistor slices comprises a current source MOSFET.

Optionally, the switch MOSFET of each of the plurality of transistor slices comprises a first switch terminal coupled to an input terminal, and a second switch terminal, and the current source MOSFET of each of the plurality of transistor slices comprises a first current source terminal coupled to the second switch terminal, a second current source terminal coupled to an output terminal, and a current source gate terminal.

Optionally, the switch MOSFET of each of the plurality of transistor slices is configured to operate in its triode region and/or the current source MOSFET of each of the plurality of transistor slices is configured to operate in its triode region.

Optionally, the current source gate terminals of each of the current source MOSFETs are coupled together, and the second current source terminals of each of the current source MOSFETs are coupled together.

Optionally, the apparatus comprises a reference circuit configured to control the current source transistors to set the first current for each of the plurality of transistor slices, wherein the first current for each of the plurality of transistor slices is approximately equal to the first current of the other transistor slices.

Optionally, the reference circuit comprises a reference slice comprising a switch reference transistor comprising a switch reference MOSFET, and a current source reference transistor comprising a current source reference MOSFET, wherein the switch reference MOSFET comprises a first switch reference terminal coupled to the input terminal, and a second switch reference terminal, and the current source reference MOSFET comprises a first current source reference terminal coupled to the second switch reference terminal, a second current source reference terminal coupled to the output terminal, and a current source reference gate terminal, the current source gate terminals of each of the current source MOSFETs are coupled to the current source reference gate terminal, and the second current source terminals of each of the current source MOSFETs are coupled to the second current source reference terminal.

Optionally, the reference circuit comprises a reference current controller configured to control the reference slice to set a second current to flow in the reference slice, such that the reference slice controls the current source transistors to set the first current for each of the plurality of transistor slices, the first current for each of the plurality of transistor slices being dependent on the second current.

Optionally, the second current is approximately equal to the first current of each of the plurality of transistor slices.

Optionally, the reference current controller is configured to receive a reference current, the second current being dependent on the reference current.

Optionally, the second current is approximately equal to the reference current.

Optionally, the reference current controller comprises a reference MOSFET comprising a first reference MOSFET terminal, a second reference MOSFET terminal coupled to the output terminal, and a reference MOSFET gate terminal coupled to the current source reference gate terminal, a reference resistive element, a first amplifier comprising a first amplifier first input terminal coupled to the first reference MOSFET terminal, a first amplifier second input terminal coupled to the output terminal via the reference resistive element, a first amplifier output node coupled to the reference MOSFET gate terminal, a second amplifier comprising a second amplifier first input terminal coupled to the first current source reference terminal, a second amplifier second input terminal coupled to the first amplifier first input terminal, and a second amplifier output terminal coupled to a switch reference gate terminal of the switch reference MOSFET.

Optionally, each of the plurality of transistor slices comprises a buffer circuit configured to provide a gate drive voltage to drive the switching of the switch MOSFET, the gate drive voltage being approximately equal to an output voltage as provided to the switch reference gate terminal by the second amplifier.

Optionally, the reference current is received at the first amplifier first input terminal and the first amplifier second input terminal.

Optionally, the pass device comprises an electrostatic discharge (ESD) protection circuit.

Optionally, each of the plurality of transistor slices comprises an ESD protection module of the ESD protection circuit, each of the ESD protection modules is coupled to the input terminal and the output terminal, during a positive ESD on the output node, each of the ESD protection modules is configured to provide a first discharge path to a first supply voltage, and provide a second discharge path to a second supply voltage, and/or during a negative ESD on the output node, each of the ESD protection modules is configured to provide a third discharge path to the first supply voltage, and provide a fourth discharge path to the second supply voltage.

Optionally, each of the ESD protection modules comprises an active clamp circuit and/or a gate coupled n-type metal oxide semiconductor (GCNMOS), a back to back diode circuit, and a body diode of the switch transistor.

Optionally, the first discharge path is provided by the active clamp circuit and/or a gate coupled n-type metal oxide semiconductor (GCNMOS), and the back to back diode circuit, the second discharge path is provided by the body diode of the switch transistor, the third discharge path is provided by the active clamp circuit and/or a gate coupled n-type metal oxide semiconductor (GCNMOS), and the back to back diode circuit, and the fourth discharge path is provided by the active clamp circuit and/or a gate coupled n-type metal oxide semiconductor (GCNMOS), and the back to back diode circuit.

Optionally, each of the plurality of transistor slices comprises an ESD protection module of the ESD protection circuit, and each of the ESD protection modules is coupled to the second current source terminal and configured to discharge the current source gate terminal, and/or the first current source terminal.

Optionally, the apparatus comprises a low dropout regulator (LDO) for receiving an input voltage and for providing an output voltage to an electrical load, the LDO comprising the pass device.

Optionally, the low dropout regulator comprises a LDO amplifier configured to receive a reference voltage and the output voltage, generate a control signal that is dependent on the reference voltage and the output voltage, and a control logic circuit configured to drive a switching operation of the pass device that is dependent on the control signal.

According to a second aspect of the disclosure there is provided a method of providing a pass device, the method comprising providing a plurality of transistor slices coupled in parallel, wherein each of the plurality of transistor slices comprises a switch transistor configured to be switchable between an on state and an off state, and a current source transistor coupled in series with the switch transistor and configured to set a first current to flow in the transistor slice when the switch transistor is in the on state.

It will be appreciated that the method of the second aspect may include using and/or providing any of the features set out in relation to the first aspect and may include other features as described herein.

### BRIEF DESCRIPTION OF THE DRAWINGS

The disclosure is described in further detail below by way of example and with reference to the accompanying drawings, in which:

FIG. 1 is a schematic of a known digital low dropout regulator (LDO);

FIG. 2A is a schematic of an apparatus comprising a pass device in accordance with a first embodiment of the present disclosure, FIG. 2B is a schematic of an apparatus comprising a specific embodiment of the pass device in accordance with a second embodiment of the present disclosure;

FIG. 3 is a schematic of an apparatus comprising a specific embodiment of the pass device and the reference circuit in accordance with a third embodiment of the present disclosure;

FIG. 4A is a schematic of an apparatus comprising the pass device and the reference circuit in accordance with a fourth embodiment of the present disclosure, FIG. 4B is a schematic of a specific embodiment of the transistor slice comprising an ESD protection module of a specific embodiment of the ESD protection circuit; and

FIG. 5 is an apparatus comprising an LDO comprising the pass device in accordance with fifth embodiment of the present disclosure.

### DETAILED DESCRIPTION

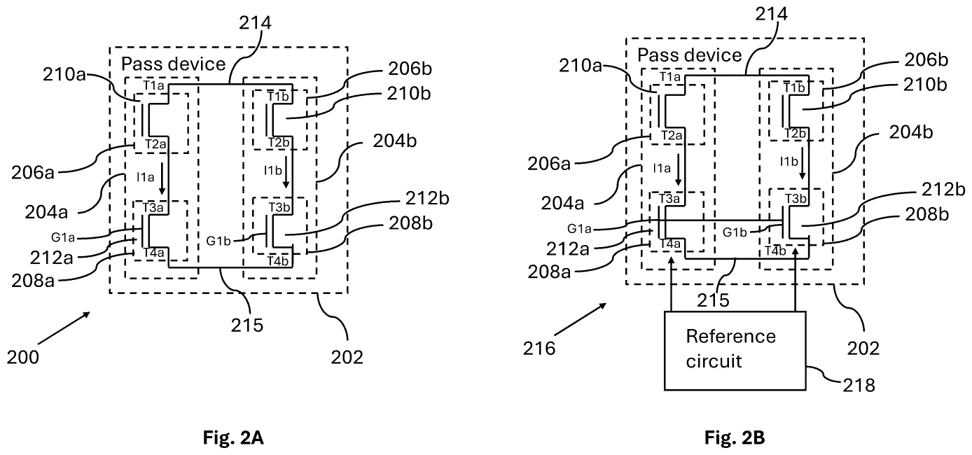

FIG. 2A is a schematic of an apparatus 200 comprising a pass device 202 in accordance with a first embodiment of the present disclosure.

The pass device 202 comprises a plurality of transistor slices 204a, 204b coupled in parallel. In the present example, two transistor slices 204a, 204b are shown. However, it will be appreciated that in further embodiments the pass device 202 may comprise more than two transistor slices 204a, 204b.

Each of the plurality of transistor slices 204a, 204b comprises a switch transistor 206a, 206b configured to be switchable between an on state and an off state and a current source transistor 208a, 208b coupled in series with the switch transistor 206a, 206b and configured to set a current I1a, I1b to flow in the transistor slice 204a, 204b when the switch transistor 206a, 206b is in the on state.

For example, in the present embodiment, the transistor slice 204a comprises the switch transistor 206a and the current source transistor 208a. The current source transistor 208a is configured to see the current I1a to flow in the transistor slice 204a when the switch transistor 206a is in the on state. Furthermore, the transistor slice 204b comprises the switch transistor 206b and the current source transistor 208b. The current source transistor 208b is configured to see the current I1b to flow in the transistor slice 204b when the switch transistor 206b is in the on state

In a specific embodiment, the currents I1a, I1b for all transistor slices 204a, 204b may be approximately equal. For example, the current I1a may be approximately equal to the current I1b.

The switch transistors 206a, 206b may each comprise switch metal oxide semiconductor field effect transistors (MOSFETs) 210a, 210b which may, for example, be p-type MOSFETs or n-type MOSFETs.

The current source transistors 208a, 208b may each comprise current source metal oxide semiconductor field effect transistors (MOSFETs) 212a, 212b which may, for example, be p-type MOSFETs or n-type MOSFETs.

The switch MOSFET 210a, 210b of each transistor slice 204a, 204b may comprise a switch terminal T1a, T1b coupled to an input terminal 214, and a switch terminal T2a, T2b.

The current source MOSFET 212a, 212b of each of the transistor slices 204a, 204b may comprise a current source terminal T3a, T3b coupled to the switch terminal T2a, T2b, and a current source terminal T4a, T4b coupled to an output terminal 215, and a current source gate terminal G1a, G1b.

For example, in the present embodiment, the switch transistor 206a comprises the switch MOSFET 210a. The switch MOSFET 210a comprises the switch terminal T1a coupled to the input terminal 214, and a switch terminal T2a.

For example, in the present embodiment, the switch transistor 206b comprises the switch MOSFET 210b. The switch MOSFET 210b comprises the switch terminal T1b coupled to the input terminal 214, and a switch terminal T2b.

For example, in the present embodiment, the current source transistor 208a comprises the current source MOSFET 212a. The current source MOSFET 212a comprises the switch terminal T3a coupled to the switch terminal T2a, and the current source terminal T4a, and the current source gate terminal G1a.

For example, in the present embodiment, the current source transistor 208b comprises the current source MOSFET 212b. The current source MOSFET 212b comprises the switch terminal T3b coupled to the switch terminal T2b, and the current source terminal T4b, and the current source gate terminal G1b.

Each switch MOSFET 210a, 210b may be configured to operate in its triode region and/or each current source MOSFET 212a, 212b may be configured to operate in its triode region.

FIG. 2B is a schematic of an apparatus 216 comprising a specific embodiment of the pass device 202 in accordance with a second embodiment of the present disclosure.

In the present embodiment, the apparatus 216 comprises a reference circuit 218 configured to control the current source transistors 208a, 208b to set the current I1a, I1b for each of the plurality of transistor slices 204a, 204b. The reference circuit 218 may control the current source transistors 208a, 208b such that the currents I1a, I1b are approximately equal to each other.

The current source gate terminals G1a, G1b of each of the current source MOSFETs 212a, 212b may be coupled together. The current source terminals T4a, T4b of each of the current source MOSFETs 212a, 212b may be coupled together.

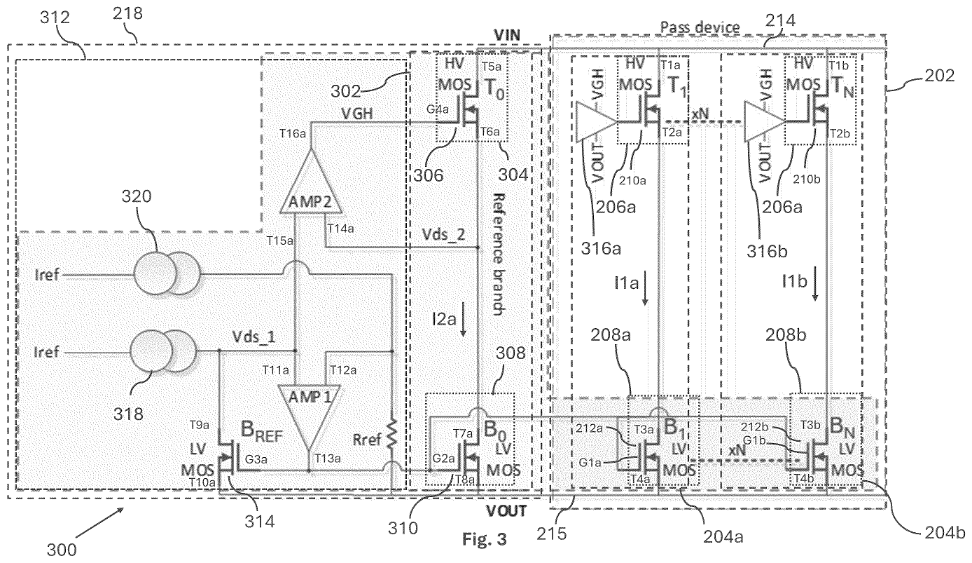

FIG. 3 is a schematic of an apparatus 300 comprising a specific embodiment of the pass device 202 and the reference circuit 218 in accordance with a third embodiment of the present disclosure.

In the present embodiment, the reference circuit 218 comprises a reference slice 302 comprising a switch reference transistor 304 comprising a switch reference MOSFET 306, and a current source reference transistor 308 comprising a current source reference MOSFET 310.

The switch reference MOSFET 306 comprises a switch reference terminal T5a coupled to the input terminal 214, and a switch reference terminal T6a. The current source reference MOSFET 310 comprises a current source reference terminal T7a coupled to the switch reference terminal T6a, a current source reference terminal T8a coupled to the output terminal 215, and a current source reference gate terminal G2a.

The current source gate terminals G1a, G1b of each of the current source MOSFETs 212a, 212b are coupled to the current source reference gate terminal G2a, and the current source terminals T4a, T4b of each of the current source MOSFETs 212a, 212b are coupled to the current source reference terminal T8a.

The reference circuit 218 may comprise a reference current controller 312 configured to control the reference slice 302 to set the current I2a to flow in the reference slice 302, such that the reference slice 302 controls the current source transistors 208a, 208b to set the currents I1a, I1b.

The current I1a, I1b for each of the plurality of transistor slices 204a, 204b is dependent on the current I2a. In a specific embodiment, the current I2a may be approximately equal to the currents I1a, I1b.

The reference current controller 312 may be configured to receive a reference current Iref. The current I2a is dependent on the reference current Iref. In a specific embodiment, the current I2a may be approximately equal to the reference current Iref. In a further specific embodiment, the currents I1a, I1b, I2a, Iref may be approximately equal.

The reference current controller 312 may comprise a reference MOSFET 314 (also labelled B_{REF}). The reference MOSFET 314 comprises a reference MOSFET terminal T9a, a reference MOSFET terminal T10a coupled to the output terminal 215, and a reference MOSFET gate terminal G3a coupled to the current source reference gate terminal G2a.

The reference current controller 312 may further comprise a reference resistive element Rref.

The reference current controller 312 may further comprise an amplifier AMP1 comprising an amplifier input terminal T11a coupled to the reference MOSFET terminal T9a, an amplifier input terminal T12a coupled to the output terminal 215 via the reference resistive element Rref, and an amplifier output node T13a coupled to the reference MOSFET gate terminal G3a.

The reference current controller 312 may further comprise an amplifier AMP2 comprising an amplifier input terminal T14a coupled to the first current source reference terminal T7a, an amplifier input terminal T15a coupled to the amplifier input terminal T11a, and an amplifier output terminal T16a coupled to a switch reference gate terminal G4a of the switch reference MOSFET 306.

Each of the plurality of transistor slices 204a, 204b may comprise a buffer circuit 316a, 316b configured to provide a gate drive voltage to drive the switching of the switch MOSFET 210a, 210b. The gate drive voltage may be approximately equal to an output voltage as provided to the switch reference gate terminal G4A by the amplifier AMP2.

The reference current Iref may be received at the amplifier input terminals T11a, T12a. The reference current Iref may be provided from one or more current sources 318, 320.

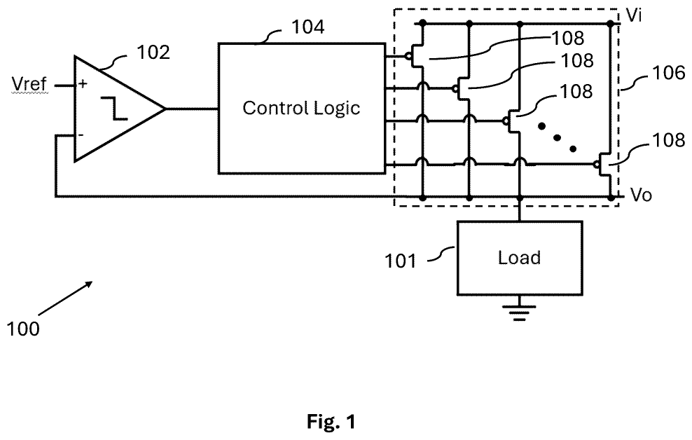

In summary, compared with known pass devices, such as presented in FIG. 1, a second “bottom” MOSFET is added in each transistor slice that controls the current flowing through the original “top” MOSFET. In the present example, the “bottom” MOSFETs are the current source MOSFETs 212a, 212b (also labelled B₁ and B_{N}) and the “top” MOSFETs are the switch MOSFETs 210a, 210b (also labelled T₁ and T_{N}).

Compared to known pass devices, each slice of the pass device 300 has been “split” into two devices in series, one acting as a switch (“top” MOSFETs, T₁ . . . T_{N}), and the other acting as an ideal precise current source (“bottom” MOSFETs, B₁ . . . B_{N}) setting the current to flow through each slice.

In the present example, the MOSFETs of the transistor slices 204a, 204b are n-type MOSFETs. However, it will be appreciated that in further embodiments, one or more of the MOSFETs may be p-type MOSFETs.

In the present example, the gates of the bottom MOSFETs 212a, 212b are shorted together and the sources of the bottom MOSFETs 212a, 212b are shorted together.

The reference slice 302 also includes a top MOSFET T₀ (the switch reference MOSFET 306) and a bottom MOSFET B₀ (the current source reference MOSFET 310).

The source of each bottom MOSFET 212a, 212b is coupled to the output terminal 215 of the slices 204a, 204b, whilst the gates of all bottom MOSFETs 212a, 212b are coupled directly to the gate of the bottom MOSFET 310 of the reference slice 302. Thus, the gate-source voltage Vgs of all bottom MOSFETs, B₁ . . . B_{N}, for each slice mirrors the gate-source voltage Vgs of the bottom MOSFET B₀ on the reference branch.

In the present embodiment where the currents Iref, I2a, I1a, I1b are approximately equal, during operation the reference current controller 312 ensures that the current I2a flowing through the bottom MOSFET 310 is approximately equal to the reference current Iref.

In the present embodiment, during operation, the reference circuit 218 ensures that the MOSFETS in each slice 204a, 204b are always in the same operating region, i.e. triode region, with precise current control of each single slice (each active slice provides a current equal to Iref).

In the present embodiment, the reference circuit 218 ensures that the correct drain-source voltage Vds is provided to the MOSFETs 310, 212a, 212b such that the predefined reference current Iref flows through them when they conduct. In the present example, this may be achieved by ensuring that the reference MOSFET 314 has equal dimensions and characteristics to the MOSFETs 310, 212a, 212, which the reference MOSFET 314 being as shown in FIG. 3 where it is coupled with the amplifier Amp1 and the reference resistive element Rref.

During operation, the reference current Iref flows through the reference resistive element Rref that creates a voltage drop Vds_1 that is copied to the drain-source voltage Vds of the reference MOSFET 314. Therefore, the reference circuit 218 may be considered to have “determined” what drain-source voltage Vds needs to be applied to the bottom MOSFETs 310, 204a, 204b to act as current sources providing the current Iref, i.e. Vds_1.

During operation, the amplifier AMP2 provides Vds_1 to the current source reference MOSFET 310, i.e. Vds_2. As the reference MOSFET 314 and the current source reference MOSFET 310 have the same voltages on their respective terminals, the current flowing through the reference slice 302 is equal to the reference current Iref. The gate of the bottom MOSFETs 204a, 204b may be directly coupled to the gate of the reference MOSFET 310 and/or the source of the bottom MOSFETs 204a, 204b may be directly coupled to the source of the reference MOSFET 310. The buffer circuits 316a, 316b may be digital buffers. During operation, the buffer circuits 316a, 316b drive the gates of the upper high voltage (HV) MOS switches (the MOSFETS 210a, 210b) to the same gate level (labelled as the voltage VGH in FIG. 3) as the HV MOS (the switch reference MOSFET 306). The switch MOSFETs 210a, 210b may be matched in layout, such that when then buffer circuits 316a, 316b each provide a gate voltage Vg to their respective switch MOSFETs 210a, 210b for turning on their MOSFETs, it is expected that each of the turned on MOSFET 210a, 210b will have the same Vds_2 as the switch reference MOSFET 306. Thus, the operating point of all transistors 210a, 210b, 212a, 212b in each slice 204a, 204b of the pass device 202 is known and controlled to match the operating point of the respective transistor 306, 310 on the reference slice 302.

In the present example, the top MOSFETs are high voltage (HV) MOSFETs and the bottom MOSFETs are low voltage (LV) MOSFETs. Using High Voltage MOSFETs on top and Low Voltage MOSFETs on bottom may maximize the dropout and the mismatch performances. However, it will be appreciated that in further embodiments, one or more of the top MOSFETs may be implemented using HV MOSFETs or LV MOSFETs, and one or more of the bottom MSOFETs may be implemented using HV MOSFETs or LV MOSFETs.

The present example includes two transistor slices 204a, 204b. However, as discussed previously, further embodiments may comprise more than two transistor slices having top and bottom MOSFETs arranged as described for the present example, in accordance with the understanding of the skilled person.

Embodiments of the present disclosure provide a precise way of knowing the exact amount of current each transistor slice of a pass device can deliver under all operating conditions. This allows more precise management of the output (for example, by enabling reconstructing the total delivered current just by knowing the number of activated slices), as well as reduce the need for a current sensing circuit, thereby providing an improved pass device over known systems.

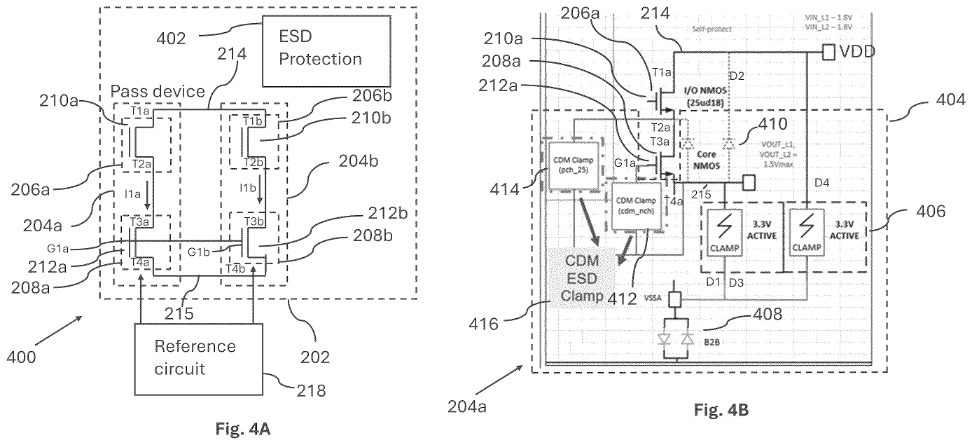

FIG. 4A is a schematic of an apparatus 400 comprising the pass device 202 and the reference circuit 218 in accordance with a fourth embodiment of the present disclosure. The pass device 202 and/or the reference circuit 218 may be implemented using any of the specific embodiments described herein, in accordance with the skilled person. In the present embodiment, the pass device 202 further comprises an electrostatic discharge (ESD) protection circuit 402 for protecting the pass device 202 from ESD.

With the split pass device architecture and design approach of the present disclosure, issues may arise regarding the cascoded (intermediate) nets (common series connected node between LV MOS Drain and HV MOS Source) of the respective slices. Transient charge build-up/voltage profile on those cascoded (intermediate) nets may cause Core LV NMOS Gate Oxide (GOX) damage. To reduce the likelihood of ESD-related damage, embodiments of the present disclosure may include the ESD protection circuit 402.

FIG. 4B is a schematic of a specific embodiment of the transistor slice 204a comprising an ESD protection module 404 of a specific embodiment of the ESD protection circuit 402.

It will be appreciated that the ESD protection circuit 402 may comprise a plurality of ESD protection modules 404 with there being an ESD protection module implemented in each of the transistor slices 204a, 204b. The ESD protection module of each slice may be implemented as described for the ESD protection module 404 of the present embodiment, in accordance with the understanding of the skilled person. Additionally, a further ESD protection modules, which may be implemented as described for the ESD protection module 402, may also be included as part of the reference slice 302 for providing ESD protection to the reference slice 302.

The ESD protection module 404 is coupled to the input terminal 214 and the output terminal 215.

During a positive ESD on the output terminal 215, the ESD protection module 404 may be configured to provide discharge path D1 to a supply voltage VSSA and provide a discharge path D2 to a supply voltage VDD.

During a negative ESD on the output terminal 215, the ESD protection module 404 is configured to provide a discharge path D3 to the supply voltage VSSA and to provide a discharge path D4 to the supply voltage VDD.

The ESD protection module 404 of the present embodiment comprises an active clamp circuit 406. In a further embodiment the ESD protection module may additionally, or alternatively, comprise a gate coupled n-type metal oxide semiconductor (GCNMOS).

The ESD protection module 404 of the present embodiment further comprises a back to back diode circuit 408 and a body diode 410 of the switch transistor 206a.

The discharge path D1 may be provided by the active clamp circuit 406 and the back to back diode circuit 408. In a further embodiment, the discharge path D1 may be provided by a GCNMOS and the back to back circuit 408. The discharge path D1 to VSSA may ultimately be provided to ground.

The ESD discharge path D1 to VSSA as illustrated in FIG. 4B, and ultimately to ground (GND) may be provided by the active clamp circuit 406 and one of the back to back (B2B) diodes of the back to back diode circuit 408.

The discharge path D2 may be provided by the body diode 410.

The discharge path D3 may be provided by the active clamp circuit 406 and the back to back diode circuit 408. In a further embodiment, the discharge path D3 may be provided by a GCNMOS and the back to back circuit 408. The discharge path D3 to VSSA may ultimately be provided to ground.

The ESD discharge path D3 to VSSA and ultimately to VSS_ESD (being ground GND) may be provided by the in-built Body Diode embedded in the BigFET of the active clamp circuit 406 and one of the B2B (Back-to-Back) Diodes of the back to back diode circuit 408.

The discharge path D4 may be provided by the active clamp circuit 406 and the back to back diode circuit 408. In a further embodiment, the discharge path D4 may be provided by a GCNMOS and the back to back circuit 408.

The ESD discharge path D4 to VDD may be provided by the in-built Body Diodes embedded in the BigFET of the active clamp circuit 406(or GCNMOS for a further embodiment including GCNMOS).

The use of the active clamp circuit 406 (or GCNMOS), the back to back diode circuit 408 and the body diode 410 to provide the discharge paths D1, D2, D3, D4 provides Primary Human Body Model (HBM) ESD protection of the Digital LDO output when implemented in an LDO. HBM ESD protection is achieved by implementing the Active Clamp (or GCNMOS) and by leveraging the self-protection capability of the in-built Body Diodes of the NMOS transistors 210a, 212a.

The MOSFET 210a may be referred to as the I/O NMOS or the I/O HV NMOS. The MOSFET 212a may be referred to as the Core LV NMOS.

The ESD protection module 404 may be coupled to the current source terminal T4a and configured to discharge the current source gate terminal G1a and/or the current source terminal T3a. The ESD protection module 404 may comprise a secondary charged device module (CDN) clamp 412 coupled to the gate terminal G1a and the terminal T4a; a secondary CDM clamp 414 coupled to the terminal T3a; and a secondary CDM clamp 416 coupled to the CDM clamps 412, 414.

The secondary CDM clamp ESD protection scheme is implemented between the Gate and Source of the MOSFET 212a as well as between the cascoded (intermediate) nodes and Source of the respective MOSFET 212a which is also the output node 215 of the Digital LDO, when implemented as part of a digital LDO, which may be provided through active clamp or ESD diode (not shown).

During operation, the CDM clamps 412, 414, 416 may quickly discharge the Gate of Core NMOS (the MOSFET 212a) and intermediate cascoded node so as not to allow excessive charge build-up on these nodes to avoid any possible Gate Oxide (GOX) damage. It will be appreciated that all slices of the pass device 202 as well as the reference slice 302 may have CDM clamps.

It will be appreciated that in further the ESD protection module 404 may provide only one of the ESD protection methods described in relation to FIG. 4B. For example, one embodiment may provide HBM ESD protection by implementing the Active Clamp (or GCNMOS) and by leveraging the self-protection capability of the in-built Body Diodes of the NMOS transistors 210a, 212a. A further embodiment may provide secondary CDM protection by using one or more of the CDM clamps 412, 414, 416. Further embodiments may provide both HBM ESD protection and secondary CDM ESD protection, as is the case in the present embodiment.

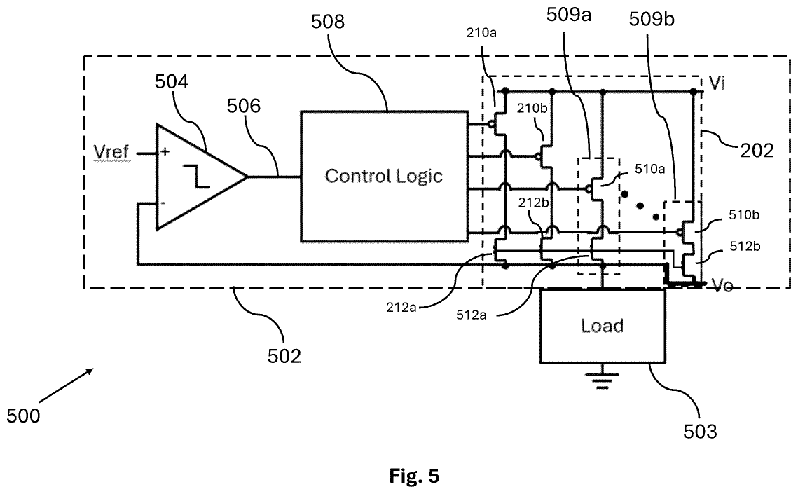

FIG. 5 is an apparatus 500 comprising an LDO 502 comprising the pass device 202 in accordance with fifth embodiment of the present disclosure. The LDO 502 is for receiving an input voltage Vi and for providing an output voltage Vo to a load 503.

The LDO 502 comprises an amplifier 504 configured to receive a reference voltage Vref and the output voltage Vo. The amplifier 504 is further configured to generate a control signal 506 that is dependent on the reference voltage Vref and the output voltage Vo. The LDO 502 further comprises a control logic circuit 508 that is configured to drive a switching operation of the pass device 202 that is dependent on the control signal 506.

It will be appreciated that some of the reference numerals of the present figure have been omitted to aid in the clarity of the drawing.

The pass device 202 in the present embodiment comprises reference slices 509a, 509b. The reference slice 509a comprises a switch MOSFET 510a and a current source MOSFET 512a. The reference slice 509b comprises a switch MOSFET 510b and a current source MOSFET 512b. It will be appreciated that in a further embodiment, the pass device 202 may be implemented as any of the pass device embodiments described herein in accordance with the understanding of the skilled person. Additionally, the apparatus 500 may further comprises the reference circuit 218 and/or the ESD protection circuit 402. The reference circuit 218 may be implemented as any of the reference circuit embodiments described herein and the ESD protection circuit 402 may be implemented as any of the ESD protection circuit embodiments described herein.

Common reference numerals and variables between figures represent common features.

Various improvements and modifications may be made to the above without departing from the scope of the disclosure.

1. An apparatus comprising:
a pass device comprising a plurality of transistor slices coupled in parallel;
wherein each of the plurality of transistor slices comprises:
a switch transistor configured to be switchable between an on state and an off state; and
a current source transistor coupled in series with the switch transistor and configured to set a first current to flow in the transistor slice when the switch transistor is in the on state.

2. The apparatus of claim 1, wherein the first current for each of the plurality of transistor slices is approximately equal to the first current of the other transistor slices.

3. The apparatus of claim 2, comprising a reference circuit configured to control the current source transistors to set the first current for each of the plurality of transistor slices.

4. The apparatus of claim 1, wherein:
the switch transistor of each of the plurality of transistor slices comprises a switch metal oxide semiconductor field effect transistor (MOSFET); and/or
the current source transistor of each of the plurality of transistor slices comprises a current source MOSFET.

5. The apparatus of claim 4, wherein:
the switch MOSFET of each of the plurality of transistor slices comprises:
a first switch terminal coupled to an input terminal; and
a second switch terminal; and
the current source MOSFET of each of the plurality of transistor slices comprises:
a first current source terminal coupled to the second switch terminal;
a second current source terminal coupled to an output terminal; and
a current source gate terminal.

6. The apparatus of claim 5, wherein the switch MOSFET of each of the plurality of transistor slices is configured to operate in its triode region and/or the current source MOSFET of each of the plurality of transistor slices is configured to operate in its triode region.

7. The apparatus of claim 5, wherein:
the current source gate terminals of each of the current source MOSFETs are coupled together; and
the second current source terminals of each of the current source MOSFETs are coupled together.

8. The apparatus of claim 7, further comprising:
a reference circuit configured to control the current source transistors to set the first current for each of the plurality of transistor slices;
wherein the first current for each of the plurality of transistor slices is approximately equal to the first current of the other transistor slices.

9. The apparatus of claim 8, wherein:
the reference circuit comprises a reference slice comprising:
a switch reference transistor comprising a switch reference MOSFET; and
a current source reference transistor comprising a current source reference MOSFET;
wherein:
the switch reference MOSFET comprises:
a first switch reference terminal coupled to the input terminal; and
a second switch reference terminal; and
the current source reference MOSFET comprises:
a first current source reference terminal coupled to the second switch reference terminal;
a second current source reference terminal coupled to the output terminal; and
a current source reference gate terminal;
the current source gate terminals of each of the current source MOSFETs are coupled to the current source reference gate terminal; and
the second current source terminals of each of the current source MOSFETs are coupled to the second current source reference terminal.

10. The apparatus of claim 9, wherein the reference circuit comprises a reference current controller configured to control the reference slice to set a second current to flow in the reference slice, such that the reference slice controls the current source transistors to set the first current for each of the plurality of transistor slices, the first current for each of the plurality of transistor slices being dependent on the second current.

11. The apparatus of claim 10 wherein the reference current controller is configured to receive a reference current, the second current being dependent on the reference current.

12. The apparatus of claim 11, wherein the reference current controller comprises:
a reference MOSFET comprising:
a first reference MOSFET terminal;
a second reference MOSFET terminal coupled to the output terminal; and
a reference MOSFET gate terminal coupled to the current source reference gate terminal;
a reference resistive element;
a first amplifier comprising:
a first amplifier first input terminal coupled to the first reference MOSFET terminal;
a first amplifier second input terminal coupled to the output terminal via the reference resistive element;
a first amplifier output node coupled to the reference MOSFET gate terminal;
a second amplifier comprising:
a second amplifier first input terminal coupled to the first current source reference terminal;
a second amplifier second input terminal coupled to the first amplifier first input terminal; and
a second amplifier output terminal coupled to a switch reference gate terminal of the switch reference MOSFET.

13. The apparatus of claim 12, wherein each of the plurality of transistor slices comprises a buffer circuit configured to provide a gate drive voltage to drive the switching of the switch MOSFET, the gate drive voltage being approximately equal to an output voltage as provided to the switch reference gate terminal by the second amplifier.

14. The apparatus of claim 12, wherein the reference current is received at the first amplifier first input terminal and the first amplifier second input terminal.

15. The apparatus of claim 7, wherein the pass device comprises an electrostatic discharge (ESD) protection circuit.

16. The apparatus of claim 15, wherein:
each of the plurality of transistor slices comprises an ESD protection module of the ESD protection circuit;
each of the ESD protection modules is coupled to the input terminal and the output terminal;
during a positive ESD on the output node, each of the ESD protection modules is configured to:
provide a first discharge path to a first supply voltage; and
provide a second discharge path to a second supply voltage; and/or
during a negative ESD on the output node, each of the ESD protection modules is configured to:
provide a third discharge path to the first supply voltage; and
provide a fourth discharge path to the second supply voltage.

17. The apparatus of claim 16, wherein each of the ESD protection modules comprises:
an active clamp circuit and/or a gate coupled n-type metal oxide semiconductor (GCNMOS);
a back to back diode circuit; and
a body diode of the switch transistor.

18. The apparatus of claim 17, wherein:
the first discharge path is provided by:
the active clamp circuit and/or a gate coupled n-type metal oxide semiconductor (GCNMOS), and the back to back diode circuit;
the second discharge path is provided by:
the body diode of the switch transistor;
the third discharge path is provided by:
the active clamp circuit and/or a gate coupled n-type metal oxide semiconductor (GCNMOS), and the back to back diode circuit; and
the fourth discharge path is provided by:
the active clamp circuit and/or a gate coupled n-type metal oxide semiconductor (GCNMOS), and the back to back diode circuit.

19. The apparatus of claim 15, wherein:
each of the plurality of transistor slices comprises an ESD protection module of the ESD protection circuit; and
each of the ESD protection modules is coupled to the second current source terminal and configured to discharge:
the current source gate terminal; and/or
the first current source terminal.

20. The apparatus of claim 1, further comprising a low dropout regulator (LDO) for receiving an input voltage and for providing an output voltage to an electrical load, the LDO comprising the pass device.

21. The apparatus of claim 20, wherein the low dropout regulator comprises:
a LDO amplifier configured to:
receive a reference voltage and the output voltage;
generate a control signal that is dependent on the reference voltage and the output voltage; and
a control logic circuit configured to drive a switching operation of the pass device that is dependent on the control signal.

22. A method of providing a pass device, the method comprising providing a plurality of transistor slices coupled in parallel;
wherein each of the plurality of transistor slices comprises:
a switch transistor configured to be switchable between an on state and an off state; and
a current source transistor coupled in series with the switch transistor and configured to set a first current to flow in the transistor slice when the switch transistor is in the on state.
